(19) United States
(12) Patent Application Publication
(10) Pub. No.: US 2003/0209683 A1
(43) Pub. Date: Nov. 13, 2003

(54) Handle-type butterfly valve

(76) Inventor: Tsai Chi-Lung, Kaohsiung City (TW)

Correspondence Address: J.C. Patents, 4 Venture, Suite 250, Irvine, CA, 92618, US

(21) Appl. No.: 10/142,194

(22) Filed: May 8, 2002

(51) Int. Cl. F16K 1/22

(52) U.S. Cl. 251/316

(57) ABSTRACT

A handle-type butterfly valve includes a body provided with valve gate for a disc valve to be movably positioned therein and a stem hole for a stem to extend therein to protrude up out of the body and connected with a handle tightly. The valve gate has an annular inner wall consisting of a larger portion and a smaller portion. Then an annular seal groove is formed in a neighboring section of the larger and the smaller portion for a seat seal to be inserted therein. Then the valve is rotated by rotation of the stem rotated by swaying of the handle to close or open the valve gate, so as to close or open the butterfly valve.

### BACKGROUND OF THE INVENTION

This invention relates to a handle-type butterfly valve, particularly to one having a simple structure for easy assembly and endurable characteristics against acid and alkali.

A known conventional handle-type butterfly valve shown in FIGS. 1, 2 and 3, includes a body 10, a handle 11 connected tightly with an upper end of a stem 12 extending in the body 10 by means of a nut 120. The stem 12 extends down in a valve gate 100 provided in the body 10, and tightly combined with a disc valve 13 movably fitted in the valve gate 100. Further a seat seal 14 made of rubber or silicon rubber (EPDM OR EPM) is provided in the valve gate 100, with the disc valve 13 rotatable by swaying of the handle 11 via the stem 12 for closing and opening the valve gate 100.

The disc valve 13 has two larger sides shaped convex and having a thicker center portion 130 and a gradually thinning portion from the thicker center portion to two smaller sides to form two flat smaller sides 132, as shown in FIGS. 3 and 4. The thicker center portion 130 has a center stem hole 131 with the same cross-sectional shape as the stem 12. Thus, the two flat smaller sides 132 may contact tightly with an annular inner surface 140 of the seat seal 14 in closing the valve gate 100, as shown in FIGS. 1 and 2.

Further, the annular inner wall of the valve gate 100 is shaped the same as the annular inner surface 142 of the seat seal 14 to prevent the seat seal 14 from falling off the body 10.

However, the structure of the seat seal 14 is so complicated and combined with the body 1 in an enveloping mode, as shown in FIGS. 2 and 3, heightening manufacturing cost accordingly. Moreover, mutual relation of the seat seal 14 and the disc valve 13 is altered by pressing and rubbing so the seat seal 14 has to be limited in its material, impossible to be made of material containing Teflon. Therefore, if the conventional butterfly valve is used in a system for transporting material including acid or alkali, the seat seal 14 may be eroded soon, resulting in leakage. In addition, the disc valve 13 is not so easy in closing and opening the valve gate 100 owing to the friction between the both, the valve 13 and the seal 14. Further, the disc valve 13 contacts with the seat seal 14 at the two smaller sides 132, and therefore the center point of the disc valve 13 and the stem 12 should be extremely accurate, or the valve 13 and the stem 12 may be hardly possible to combine with each other very closely, giving rise to flaws in their quality.

### SUMMARY OF THE INVENTION

This invention has been devised to offer a handle-type butterfly valve having a simple structure to be made with low cost and able to endure acid and alkali.

The invention has features described below.

1.The butterfly valve in the invention has a body combined with a handle, and a stem connected and moved together with the handle. The stem extends down to a valve gate formed in the body to combine with a disc valve. The valve gate has an inner wall provided with a seat seal for the disc valve to contact or leave for closing and opening the butterfly valve smoothly.

2.The disc valve and the seat seal can contact with each other with extremely small friction, enabling an operator may close and open the butterfly valve by swaying the handle with only a little force.

3.The seat seal can be combined with the disc valve with easiness and quickness, and also be made of many various proper materials such as rubber, silicon rubber, Teflon, etc.

### BRIEF DESCRIPTION OF DRAWINGS

This invention will be better understood by referring to the accompanying drawings, wherein:

FIG. 1 is a side cross-sectional view of a known conventional handle-type butterfly valve;

FIG. 2 is a cross-sectional view of the line I-I in FIG. 1;

FIG. 3 is a cross-sectional view of the conventional handle-type butterfly valve in an opened condition;

FIG. 4 is a cross-sectional view of the line II-II in FIG. 1;

FIG. 5 is a side view of a handle-type butterfly valve in the present invention;

FIG. 6 is a cross-sectional view of the line III-III in FIG. 5;

FIG. 7 is a cross-sectional view of the handle-type butterfly valve in an opened condition in the present invention;

FIG. 8 is a cross-sectional view of the handle-type butterfly valve in the present invention; and,

FIG. 9 is a cross-sectional view of the line V-V in FIG. 5.

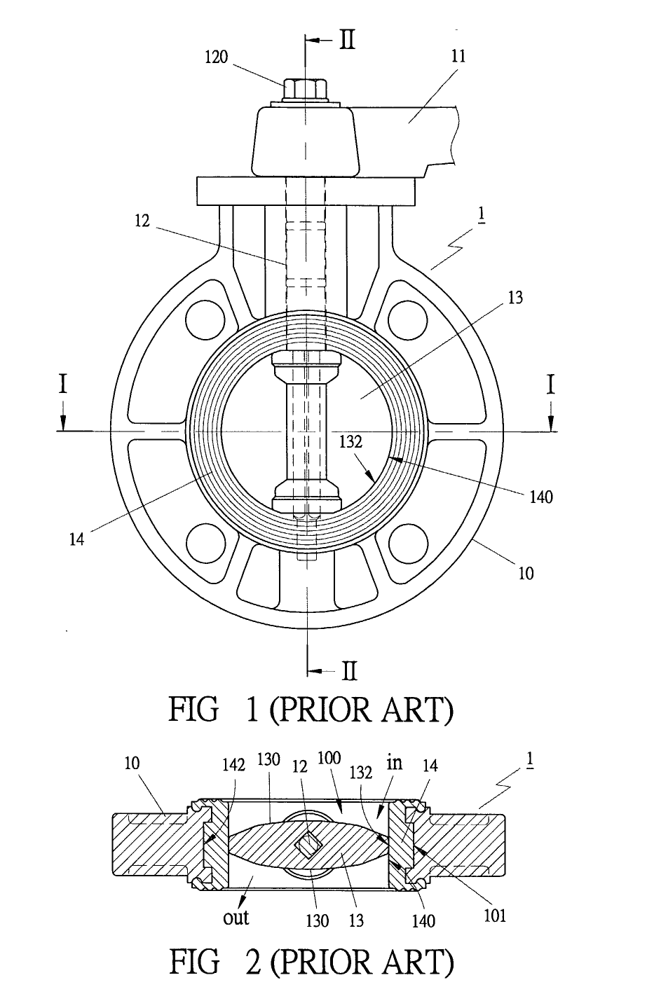

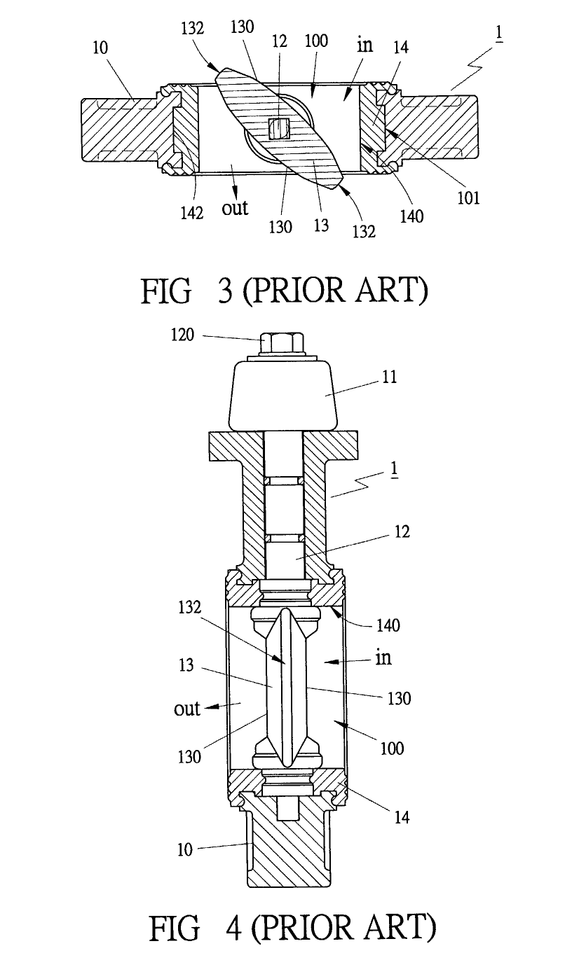

### DETAILED DESCRIPTION OF THE PREFERRED EMBODIMENT

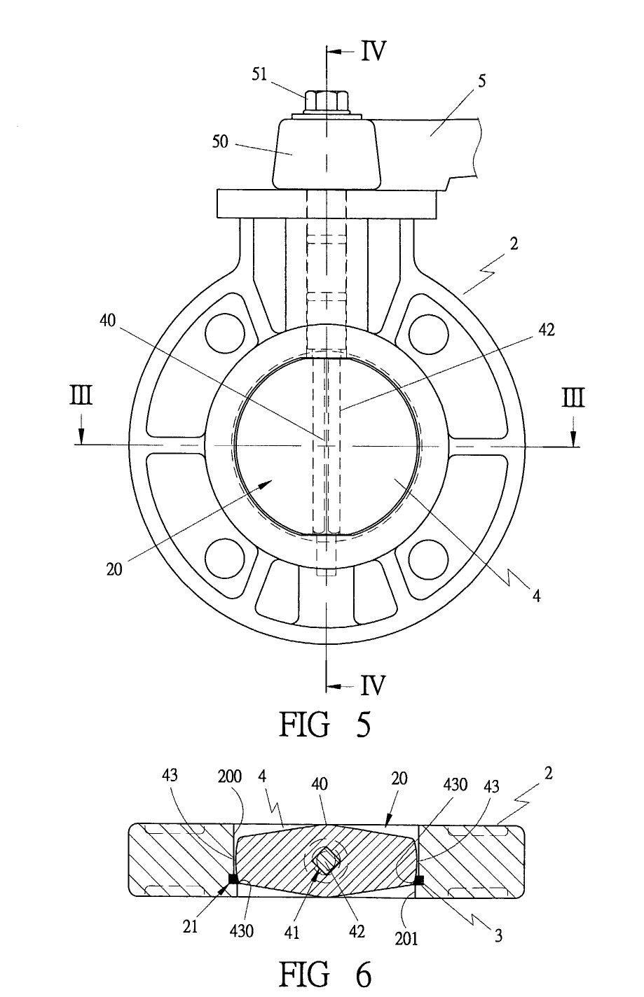

A preferred embodiment of a handle-type butterfly valve in the present invention, as shown in FIGS. 5 and 6, includes a body 2, a seat seal 3, a disc valve 4, a handle 5, and a stem 42 as main components combined together.

The body 2 has a valve gate 20 formed in a lower portion, which is formed with a large diametrical circumferential surface 200 and a small diametrical circumferential surface 201 in an annular wall, and an annular seal groove 21 formed in a neighboring section of the large and the small diametrical circumferential surface 200 and 201. Then the seat seal 3 is inserted in the annular seal groove 21 and stopped and secured by the large diametrical circumferential surface 200 to perform sealing function thoroughly.

The disc valve 4 is movably deposited in the valve gate 20, having a center portion 40 bored with a center stem hole 41 shaped as the stem 42 for the stem 42 to insert therein. Further, the disc valve 4 has two larger sides shaped to taper gradually from the center point to the two smaller sides, forming two convex smaller sides 43.

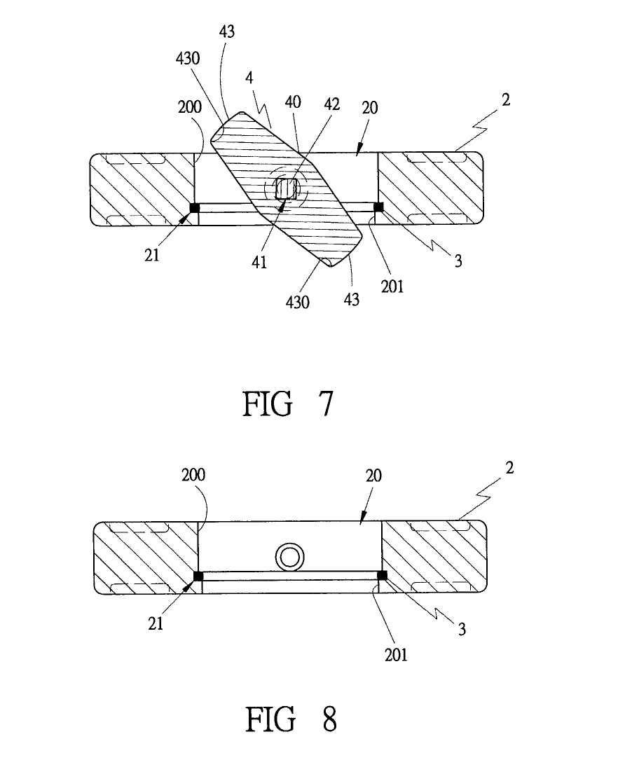

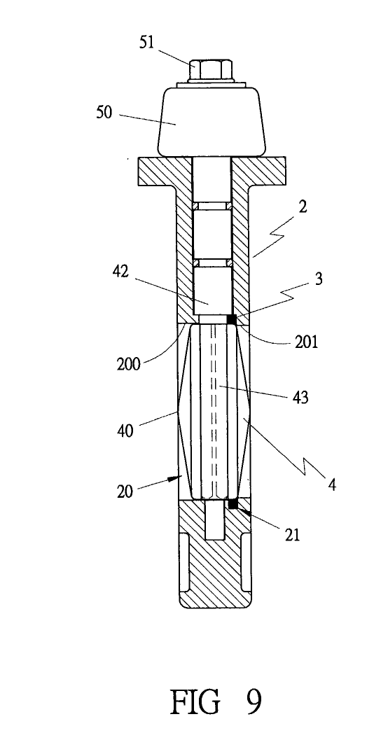

The stem 42 has an upper end portion engaging with one end 50 of the handle 5, and secured tightly by means of a nut 51 screwing with the stem 42. Then when the handle 5 is swayed for an angle, the stem 42 is also turned for the same angle, forcing the disc valve 4 rotate for the same angle in closing and opening the valve gate 20, as shown in FIGS. 6 and 7.

The disc valve 4 has an outer edge 430 formed in the outer end surface 43 for squeezing and pressing the seat seal 3 to perform sealing function, and therefore, it does not need a large force to close and open the butterfly valve by moving the handle 2. Thus, there is not a large friction occurring between the disc valve 4 and the seat seal 3 in closing and opening the butterfly valve in the invention. Then the seat seal 3 can be made of materials having an excellent enduring property against acid and alkali, such as rubber, silicon rubber, Teflon, etc.

In short, squeezing and pressing operation of the disc valve 4 against the seat seal 3 does not depend on the whole two convex smaller sides 43, so the stem 42 does not necessarily positioned in the very center of the body 2 in order to secure no leakage, convenient and worthy in practical manufacture.

While the preferred embodiment of the invention has been described above, it will be recognized and understood that various modifications may be made therein and the appended claims are intended to cover all such modifications that may fall within the spirit and scope of the invention.

What is claimed is:

1. A handle-type butterfly valve comprising a body, said body provided with a valve gate in a lower portion, said valve gate having an annular inner wall, said annular inner wall provided with an annular seal groove for a seat seal to be inserted therein, a disc valve movably positioned in said valve gate and having a center portion bored with a stem hole and two convex smaller sides, a stem provided to extend in said body and having its upper end portion protruding out of said body, said upper end portion of said stem connected tightly with an end of a handle by means of a nut so that said stem may be rotated by swaying said handle for a certain angle, said disc valve connected tightly with a lower end portion of said stem so that said disc valve may be rotated by said stem for the certain angle to close or open said valve gate in said body.

2. The handle-type butterfly valve as claimed in claim 1, wherein said valve gate of said body has said annular inner wall consisting of a large diametrical portion and a small diametrical portion.

3. The handle-type butterfly valve as claimed in claim 1, wherein a neighboring portion of said large diametrical circumferential portion and said smaller diametrical circumferential portion of said annular inner wall of said valve gate is formed with an annular seal groove for said seat seal to be inserted therein.

4. A handle-type butterfly valve as claimed in claim 1, wherein said disc valve has a center portion bored with a stem hole, and two larger sides respectively tapering gradually from a center point to two smaller sides.
